(19) United States
(12) Patent Application Publication
(10) Pub. No.: US 2022/0077940 A1
(43) Pub. Date: Mar. 10, 2022

(54) ELECTRONIC APPARATUS, ELECTRONIC SYSTEM, METHOD, AND COMPUTER PROGRAM

(71) Applicant: KABUSHIKI KAISHA TOSHIBA, Tokyo (JP)

(72) Inventors: Takafumi SAKAMOTO, Machida Tokyo (JP); Daisuke UCHIDA, Kawasaki Kanagawa (JP)

(73) Assignee: KABUSHIKI KAISHA TOSHIBA, Tokyo (JP)

(21) Appl. No.: 17/249,363

(22) Filed: Feb. 26, 2021

(30) Foreign Application Priority Data
Sep. 8, 2020 (JP) 2020-150755

(51) Int. Cl. H04B 17/18; H04W 24/10; H04B 17/318

(52) U.S. Cl. CPC H04B 17/18; H04B 17/318; H04W 24/10

(57) ABSTRACT

An electronic apparatus includes a processor configured to determine, among first wireless communication apparatuses arranged at first positions in an environment, a second wireless communication apparatus and a third wireless communication apparatus based on a fault to be detected in the environment, the third wireless apparatus measuring first information associated with propagation of a radio wave with the second wireless communication apparatus.

### CROSS REFERENCE TO RELATED APPLICATIONS

This application is based upon and claims the benefit of priority from the prior Japanese Patent Application No. 2020-150755, filed on Sep. 8, 2020, the entire contents of which are incorporated herein by reference.

### FIELD

Embodiments described herein relate to an electronic apparatus, an electronic system, a method, and a computer program.

### BACKGROUND

A technology has been proposed that detects a fault occurring in an ambient environment provided with wireless apparatuses, from propagation information on radio waves measured between the wireless apparatuses. For example, there is a technology that measures an RSSI (Received Signal Strength Indicator) between two wireless apparatuses, and detects movement of an object if variation in RSSI is high. There is also a technology that detects the humidity of soil serving as a target, based on the RSSI measured between two antennas.

It is unfortunately difficult for any of the technologies to detect multiple types of faults.

### BRIEF DESCRIPTION OF THE DRAWINGS

FIG. 1 shows a communication system according to a first embodiment;

FIG. 2 shows a specific configuration example of the communication system;

FIG. 3 shows a specific configuration example of the communication system;

FIG. 4 shows a specific configuration example of the communication system;

FIG. 5 shows a specific configuration example of the communication system;

FIG. 6 is a block diagram of a fault detection apparatus that includes an information processing apparatus according to the first embodiment;

FIG. 7 is a flowchart showing an example of an operation of an input device of the fault detection apparatus acquiring setting information;

FIG. 8 is a flowchart showing an example of an operation of a processor;

FIG. 9 is a flowchart showing an example of an operation of an estimator;

FIG. 10 shows an example of wireless apparatuses to be selected to detect a fault occurring in a wide area.

FIG. 11 shows an example of wireless apparatuses to be selected to detect a fault occurring in a small area.

FIGS. 12A and 12B show examples of observation duration and acquisition cycles in cases of detecting faults that are continuously present for long and short duration;

FIG. 13 is a block diagram of a fault detection apparatus according to a second embodiment; and

FIG. 14 shows a hardware configuration of the fault detection apparatus (information processing apparatus) in FIG. 1.

### DETAILED DESCRIPTION

An electronic apparatus includes a processor configured to determine, among first wireless communication apparatuses arranged at first positions in an environment, a second wireless communication apparatus and a third wireless communication apparatus based on a fault to be detected in the environment, the third wireless apparatus measuring first information associated with propagation of a radio wave with the second wireless communication apparatus.

Hereinafter, referring to the drawings, embodiments of the present invention are described. In the following description, elements identical or similar to described elements are assigned the same symbols, and redundant description is basically omitted. For example, if there are identical or similar elements, common symbols are sometimes used for description without discrimination between the elements. In multiple diagrams, corresponding elements are assigned the same symbols, and detailed description is sometimes omitted.

### First Embodiment

This embodiment relates to a fault detection apparatus that efficiently detects occurrence of a fault to be detected, in an environment where multiple wireless communication apparatuses (hereinafter, wireless apparatuses) are installed. In particular, for each type of faults to be detected, multiple wireless apparatuses caused to measure propagation situations of radio waves are selected, and presence or absence of a fault is detected based on first information (propagation information or propagation characteristic) about propagation of radio waves measured between the selected wireless apparatuses. According to this embodiment, measurement of the first information about radio wave propagation encompasses measurement of propagation information, and calculation of propagation characteristic, in the following description. The embodiments are hereinafter described in detail.

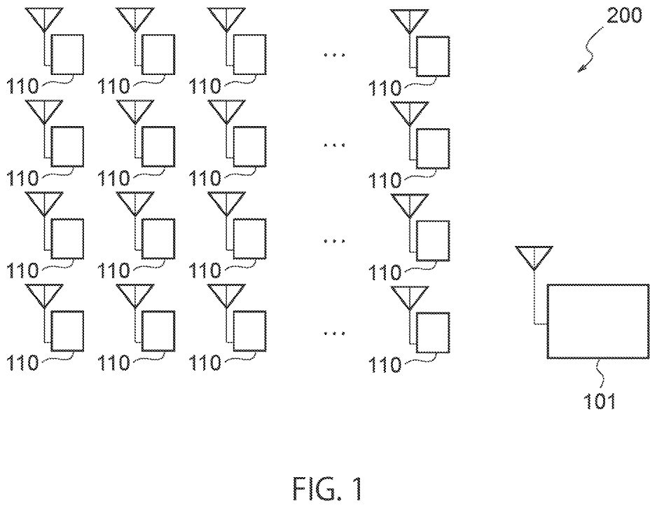

FIG. 1 shows a communication system 200 according to the first embodiment. The communication system 200 includes a fault detection apparatus 101 that is an information processing apparatus according to this embodiment, and multiple wireless apparatuses (wireless communication apparatuses) 110. The fault detection apparatus 101 selects the multiple wireless apparatuses 110 according to faults to be detected, acquires propagation characteristic based on propagation information on radio waves between the selected wireless apparatuses 110, and detects presence or absence of a fault on the basis of the propagation characteristic. For example, in a case where the multiple wireless apparatuses 110 are provided at or adjacent to solar panels (solar photovoltaic modules), occurrence of faults such as of weeds and deposited snow, and occurrence of faults such as of intrusion of wildlife or prowlers are detected. Note that the communication system 200 may be called an information processing system.

The fault detection apparatus 101 and each wireless apparatus 110 can communicate with each other. The wireless apparatuses 110 can also communicate with each other. FIG. 1 shows a case where such communication is wirelessly performed. However, at least a part of such communication may be performed in a wired manner. For each type of faults to be detected, the fault detection apparatus 101 causes the selected wireless apparatuses 110 to measure propagation information and to feed back, to the fault detection apparatus 101, information on propagation characteristic calculated from the measured propagation information. This can reduce the amount of communication and the amount of calculation required to detect faults while keeping a high detection accuracy in comparison with a case of causing all the wireless apparatuses 110 to perform measurement exhaustively between all the wireless apparatuses 110. Consequently, power consumption of both the fault detection apparatus 101 and the wireless apparatuses 110 can be reduced, and the communication band can be saved.

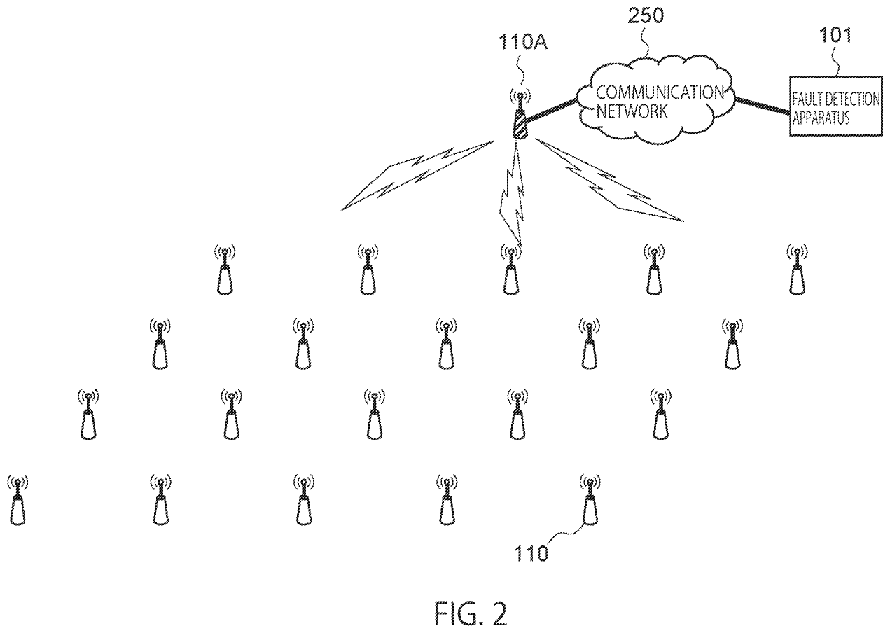

FIGS. 2, 3, 4 and 5 show specific configuration examples of the communication system 200.

In the example of FIG. 2, the fault detection apparatus 101 is provided, as a server, on a communication network 250, such as the Internet. For example, the fault detection apparatus 101 is a server in a cloud. The fault detection apparatus 101 communicates with the multiple wireless apparatuses 110 via the communication network 250. A base station 110A, such as an access point, is connected to the communication network 250 in a wired or wireless manner. The multiple wireless apparatuses 110 communicate with the fault detection apparatus 101 through the base station 110A. A plurality of the base stations 110A may be installed. One of the wireless apparatuses 110 may also have the function of the access point. In this case, the one of the wireless apparatuses 110 serves as a master, and the remaining wireless apparatuses 110 serve as slaves. Note that each wireless apparatus 110 is not necessarily capable of communicating with all the remaining wireless apparatuses 110 on a one-to-one basis.

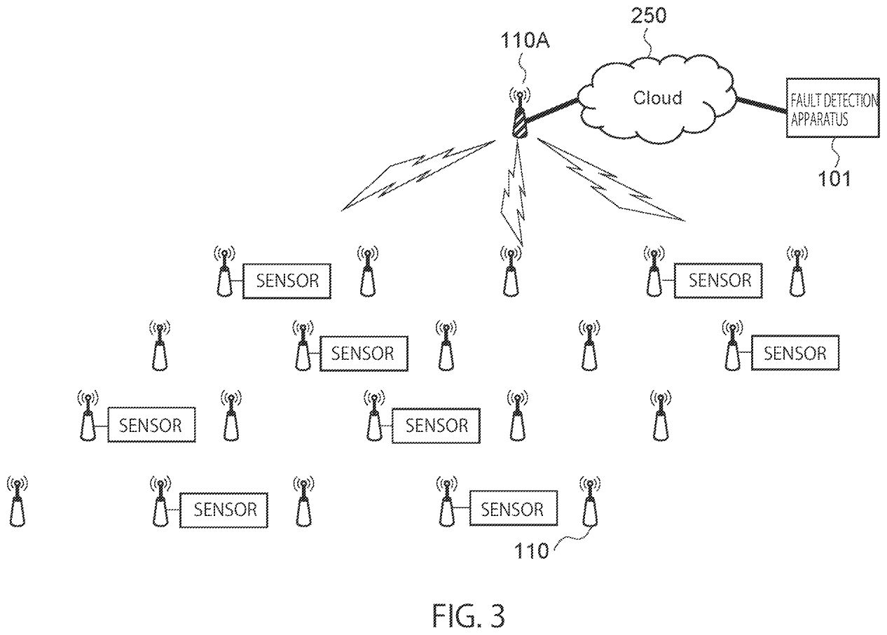

In the example of FIG. 3, some of wireless apparatuses 110 are provided respectively with sensors. Each sensor senses at least one of the ambient environment of the wireless apparatus 110 and equipment provided with the wireless apparatus 110. The fault detection apparatus 101 can acquire information (sensing information) acquired by sensing through the sensor from the wireless apparatus 110. Examples of the sensors include a camera, an actinometer, a rain gauge, and a snow gage.

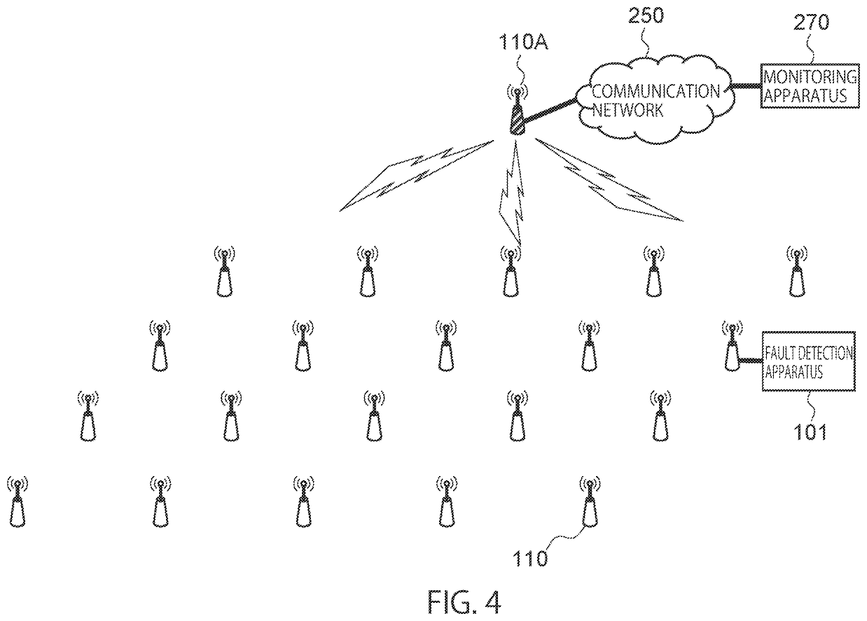

In the example of FIG. 4, the fault detection apparatus 101 is connected to at least one of the wireless apparatuses 110. The fault detection apparatus 101 may be implemented as software in the one wireless apparatus 110, or be connected to an external port of the wireless apparatus 110 through a wired cable. A monitoring apparatus 270 is connected to the communication network 250. The monitoring apparatus 270 monitors, through each wireless apparatus 110, the state of equipment and the like at which the corresponding wireless apparatus 110 is installed.

For example, in a case where the wireless apparatus 110 is provided at a solar panel, this apparatus monitors the operation state, such as a power generation output and a power generation efficiency at predetermined timing.

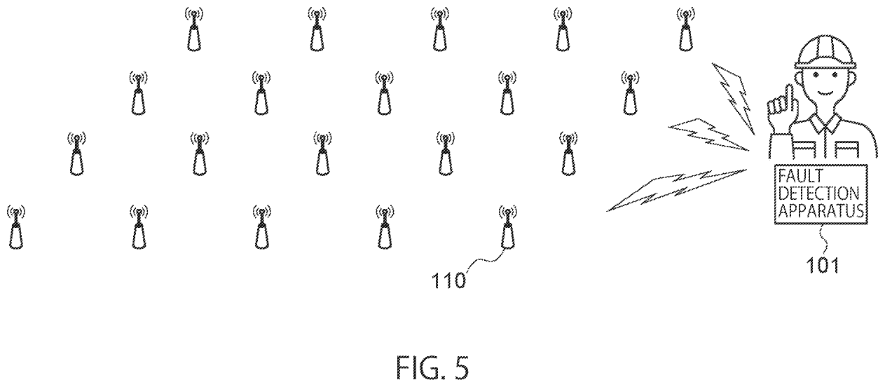

In the example of FIG. 5, the fault detection apparatus 101 is implemented as software in a mobile terminal held by an operator. The fault detection apparatus 101 wirelessly communicates directly with each wireless apparatus 110. The scheme of communication between the fault detection apparatus 101 and each wireless apparatus 110 is not limited to wireless one and may be wired one instead. For example, the operator travels round in a target area, thereby allowing the fault detection apparatus 101 to communicate with each wireless apparatus 110.

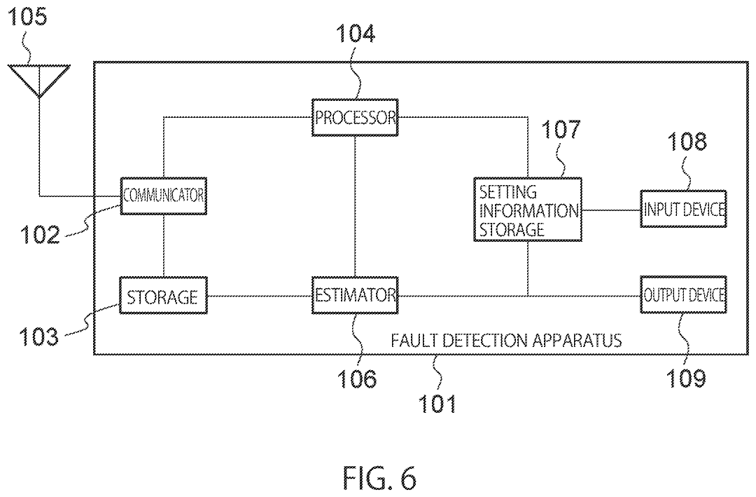

FIG. 6 is a block diagram of the fault detection apparatus 101 that includes an information processing apparatus according to the first embodiment.

The fault detection apparatus 101 includes a communicator 102, a storage 103, a processor 104, an antenna 105, an estimator 106, a setting information storage 107, an input device 108, and an output device 109.

The communicator 102 can communicate with the multiple wireless apparatuses 110 via the antenna 105. The communicator 102 may be capable of communicating with the base station 110A. The communication includes at least one of exchange required for the communication, and transmission and reception of a signal. Any of wireless communication standards including Wi-Fi®, Bluetooth®, and UWB (Ultra Wide Band) is applicable. The communication performed in the communicator 102 is not limited to wireless communication, and may be wired communication, such as of Ethernet®. In this case, no antenna 105 is required to be provided.

The input device 108 is an interface that acquires, as setting information, information required to operate the fault detection apparatus 101. The input device 108 may be a device, such as a keyboard, a mouse, a touch panel or a gesture input device, operated by the operator or the like, or a communication device that acquires information from a terminal operated by the operator through wired or wireless communication. Alternatively, the input device 108 may be a device that acquires setting information from a terminal operated by the operator through the communicator 102.

Examples of setting information acquired by the input device 108 include, for each type of faults to be detected: IDs of multiple (e.g., two) wireless apparatuses caused to measure information on a radio wave environment (propagation information); the type of propagation information to be measured; and the type of propagation characteristic calculated from the measured propagation information. The examples also include: a duration (measurement duration) during which the multiple wireless apparatuses are caused to perform measurement; and at least one of the number of measurements for measurement in the measurement duration, and the measurement interval. The examples further include positions at which the multiple wireless apparatuses 110 are installed. In this case, a condition about the position, such as the distance between the wireless apparatuses caused to measure propagation information, may be input, and the IDs of the wireless apparatuses may be determined in the fault detection apparatus 101. Another example of the setting information is information that represents a criterion (fault detection criterion) about the propagation characteristic for determining presence or absence of a fault, for each type of faults to be detected. The propagation information and the propagation characteristic are examples of information exchanged between the wireless apparatuses according to this embodiment.

The setting information storage 107 stores the setting information acquired by the input device 108. The setting information may be thus acquired by the input device 108; alternatively, the information may be preliminarily written in the setting information storage 107.

The processor 104 selects multiple (e.g., two) wireless apparatuses 110 according to the fault type to be detected, based on the setting information stored in the setting information storage 107. The processor 104 instructs the communicator 102 to transmit instruction data for instruction of detecting a fault, to at least one of the selected wireless apparatuses 110. The instruction data includes an instruction for measuring the propagation information, an instruction for calculating the propagation characteristic, and a condition of measurement defined in the setting information (e.g., at least one of a type of propagation information to be measured, a type of propagation characteristic to be calculated, a measurement duration, a measurement cycle (measurement interval), and the number of measurements).

The processor 104 acquires information (propagation characteristic information) representing the propagation characteristic between the multiple wireless apparatuses 110 via the communicator 102. That is, the communicator 102 receives the propagation characteristic information from at least one of the selected wireless apparatuses 110, and provides the processor 104 with the received propagation characteristic information. The processor 104 associates the acquired propagation characteristic information with the IDs of the wireless apparatuses 110, and stores the associated information in the storage 103. The processor 104 acquires information (sensing information) sensed by the sensors provided at the wireless apparatuses 110 via the communicator 102, and associates the acquired sensing information with the IDs of the wireless apparatuses 110 and stores the associated information in the storage 103. When the information acquired from the wireless apparatuses 110 is stored in the storage 103 (propagation characteristic information, sensor information, etc.), not only the IDs of the wireless apparatuses 110 but also time information (time at which the information is acquired, time at which the propagation information is measured, etc.) may be stored.

The storage 103 stores the information acquired from the wireless apparatuses 110 (propagation characteristic information, sensor information, etc.) in association with the IDs of the wireless apparatuses 110. When the propagation characteristic information is acquired, not only the ID of the wireless apparatus 110 from which the propagation characteristic information has been acquired but also that of the wireless apparatus with which the wireless apparatus concerned has performed measurement is stored. The storage 103 is a memory or the like and is, for example, a RAM (Random Access Memory), a PROM (Programmable ROM), an EPROM (Erasable PROM), an EEPROM (Electrically EPROM), a flash memory, a register or the like. The storage 103 may be provided in the fault detection apparatus 101. Alternatively, this storage may be provided outside, or may be in a cloud for storing information via the Internet.

The estimator 106 estimates presence or absence of a fault, on the basis of the propagation characteristic information acquired by the processor 104, and the fault detection criterion corresponding to the fault type to be detected. Upon detection of occurrence of a fault, the estimator 106 estimates the position at which the fault occurs.

The output device 109 presents an estimation result of the fault by the estimator 106, to the operator or the like. This estimation result includes an estimation result of presence or absence of the fault, and information representing the position and the like at which the fault is present (detection result information). For example, the output device 109 outputs the detection result information to a display device in at least one form of video and audio modes. Examples of the display device include a liquid crystal display, an organic EL display device, and a plasma display device. The display device may be provided as a part of the fault detection apparatus 101. The output device 109 may be a communication device that transmits data including the detection result information to a terminal of the operator. The input device 108 and the output device 109 may be configured integrally as a touch panel.

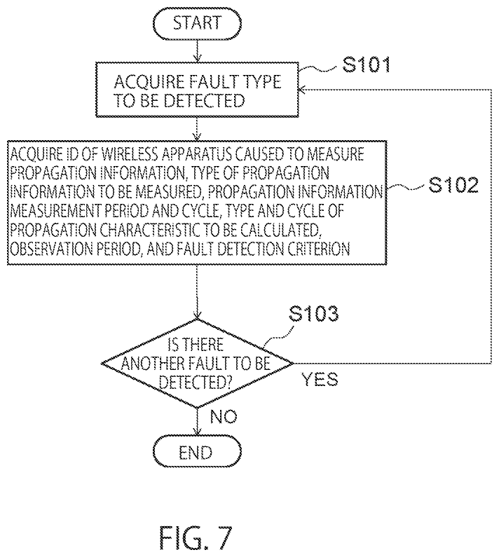

The configuration example of the fault detection apparatus 101 has thus been described. The processor 104 and the estimator 106 may be achieved by a processing apparatus. The processing device is one or more electronic circuits that include a control device and an operation device, for example. The electronic circuits can be achieved as analog or digital circuits. For example, any of a general-purpose processor, a central processing unit (CPU), a microprocessor, a digital signal processor (DSP), an ASIC, an FPGA, and a combination thereof can be adopted. The operation example of the fault detection apparatus 101 configured as described above is described with reference to flowcharts of FIGS. 7, 8 and 9.

FIG. 7 is a flowchart showing an example of the operation of the input device 108 of the fault detection apparatus 101 acquiring setting information. For example, input device 108 acquires, from the operator, information on the wireless apparatus caused to perform measurement and on propagation information to be measured, with respect to the fault type to be detected. The information is thus acquired through input from the operator; alternatively, the information may be acquired in a method of reading from an external storage device, or a method of receiving communication from the terminal operated by the operator. Details of the operation of the flowchart of FIG. 7 are hereinafter described.

First, the input device 108 acquires information that designates a fault type to be detected (S101).

The input device 108 acquires information required to detect a fault (S102). Specifically, information designating multiple wireless apparatuses that measure the propagation information is acquired. The methods of designating the wireless apparatuses include a method of designating the IDs (identifiers) of wireless apparatuses, and a method of designating the condition of wireless apparatus. The method of designating the condition of the wireless apparatus may designate the condition of the distance between wireless apparatuses that measure the propagation information. In this case, the fault detection apparatus 101 selects the wireless apparatuses that measure the propagation information on the basis of arrangement position information on the wireless apparatuses and the like. Coordinates or the like that designate the geographical range may be adopted. In this case, the fault detection apparatus 101 selects wireless apparatuses installed in this range.

Furthermore, the input device 108 acquires information about the measurement method, such as the type of propagation information to be measured, propagation information measurement time, the measurement cycle (measurement interval), and the number of measurements. For example, the propagation information may be the RSSI (Received Signal Strength Indicator) that is strength information on a signal exchanged between wireless apparatuses, a signal propagation time duration (a time duration from signal transmission to reception), the number of signal receptions, a signal reception time, a sequence number (assigned on the transmission side) included in the received signal, etc. In the case of example of RSSI, the cycle of transmitting the signal for measuring the RSSI, and measurement time information may be acquired. Furthermore, at least one piece of information among measurement start time, measurement completion time, the number of transmissions and the like.

The input device 108 acquires information on the type of propagation characteristic calculated from the propagation information, the cycle (acquisition cycle) of acquiring the propagation characteristic from the wireless apparatus, and the observation duration (the duration of acquiring the propagation characteristic) of observing the propagation characteristic to detect a fault. Examples of the propagation characteristic include the maximum value of RSSI, the mean value, the standard deviation, the PER (Packet Error Rate), and the minimum propagation time.

The input device 108 acquires the fault detection criterion that is a criterion for detecting a fault. An example of the fault detection criterion is a threshold for comparison with the propagation characteristic acquired from the target wireless apparatus. In this case, presence or absence of a fault can be estimated by comparison of the value of the propagation characteristic acquired from the wireless apparatus with the threshold. Note that in order to facilitate detection of a fault to be detected, it is desirable to set the fault detection criterion to a different one according to the fault characteristic. It is conceivable to designate the fault detection criterion that varies according to the fault type.

The information acquired through the input device 108 is stored as setting information in the setting information storage 107.

The information acquired in step S102 is not necessarily the entire information described above. For example, the information to be acquired may be only information designating the wireless apparatus. Other information is preset in each wireless apparatus 110. When each wireless apparatus 110 is designated, this wireless apparatus 110 may measure the propagation information and calculate the propagation characteristic on the basis of preset information.

If multiple types of faults are required to be detected (YES in S103), steps S101 and S102 are repeated, and the operator inputs information required to detect each type of faults. If at least a part of information required to detect a fault has already been acquired when steps S101 and S102 are repeated, the input device 108 may omit acquisition of the corresponding information. If the entire information about the types of faults required to be detected has been input (NO in S103), this processing is finished.

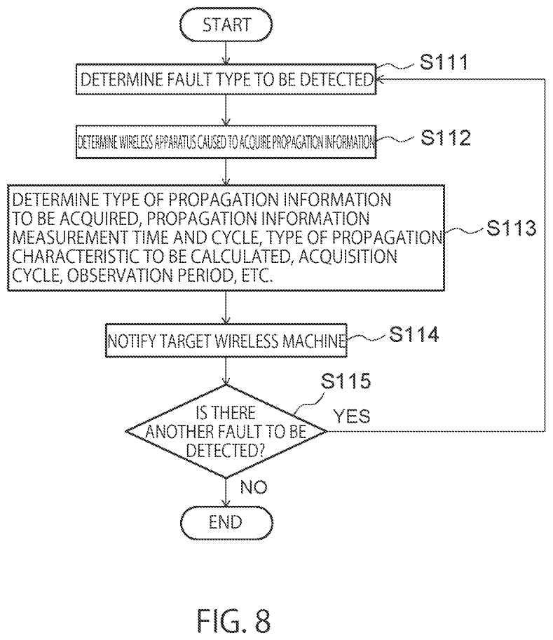

FIG. 8 is a flowchart of an example of an operation of the processor 104 instructing the target wireless apparatus to measure the propagation information and calculate the propagation characteristic about a fault type to be detected.

The fault detection apparatus 101 determines the fault type to be detected (S111). The processor 104 may sequentially select the type from among the fault types set in the setting information storage 107, or the operator may designate the type through the input device 108.

Next, the processor 104 may determine multiple wireless apparatuses caused to measure the propagation information in order to detect the fault type determined in step S111 (S112). The wireless apparatus is determined, for example, by selecting the wireless apparatus associated with the fault type to be detected, in the setting information storage 107.

Next, the processor 104 determines the condition of the propagation information to be measured by the selected wireless apparatus, and the condition of propagation characteristic to be calculated (S113). Specifically, in the setting information storage 107, the type of propagation information associated with the fault to be detected, the propagation information measurement time, propagation information measurement cycle and the like are selected. The type of propagation characteristic to be calculated, the propagation characteristic acquiring cycle, the propagation characteristic observation duration and the like are determined.

Next, the processor 104 transmits measurement instruction data including the condition of the propagation information and the condition of the propagation characteristic to be calculated, which are determined in step S113, to at least one of the wireless apparatuses selected in step S112 (S114). That is, the processor 104 transmits, via the communicator 102, a signal including an instruction for measuring the propagation information. According to the condition of the instruction by the processor 104, the selected wireless apparatus measures the propagation information required to detect a fault, and calculates the propagation characteristic on the basis of the measured propagation information.

If there are multiple fault types to be detected (YES in S115), the processor 104 performs the operations in steps S111 to S114 to all the fault types to be detected. Accordingly, the corresponding wireless apparatuses can be caused to measure the propagation information required to detect all the fault types, and the propagation characteristic can be calculated. If instruction data for all the fault types required to be detected is transmitted (NO in S115), this processing is finished.

Note that irrespective of presence or absence of reception of the instruction data from the fault detection apparatus 101, the wireless apparatus 110 may steadily measure the propagation information. In this case, the wireless apparatus may calculate the propagation characteristic corresponding to the condition designated by the instruction data, from the propagation information corresponding to the condition designated by the instruction data, and transmit the characteristic to the fault detection apparatus 101. In a second embodiment described later, the wireless apparatus having measured the propagation information transmits the propagation information to the fault detection apparatus 101, and the fault detection apparatus 101 calculates the propagation characteristic. In this embodiment, the propagation characteristic are calculated by the wireless apparatus. Accordingly, the traffic in a wireless section can be prevented from increasing. For example, if communication of the state monitoring for each wireless apparatus is performed by the monitoring apparatus 270, the possibility of delay of communication of state monitoring due to congestion by communication of the propagation information can be reduced, and smooth continuation can be achieved.

The operation in FIG. 8 may start at the start of system operation or the like, and subsequently be steadily performed. Alternatively, in response to an instruction by the user, the operation in FIG. 8 may be started.

For the sake of monitoring the system or the like, each wireless apparatus transmits the state information on equipment connected to each wireless apparatus to the fault detection apparatus 101, and the processor 104 of the fault detection apparatus 101 may determine execution of fault detection in FIG. 8 on the basis of the state information.

For example, in a case of a mega-solar monitoring system, many solar panels (power generation equipment) are provided for a mega-solar system, and power is generated by sunlight. To monitor the power generation situations, for each predetermined number of solar panels, information (state information), such as on voltage and current pertaining to generated power, is transmitted to the fault detection apparatus 101 through the wireless apparatus installed at or adjacent to the solar panels. The fault detection apparatus 101 stores the state information in the storage 103. If reduction in generated power is detected based on the state information, the processor 104 or the monitoring apparatus 270 estimates the type of a certain fault having a possibility of occurrence on the basis of the state information in the storage 103, and execution of fault detection is determined.

In this case, if the position of a fault that possibly occurs can be estimated by monitoring the state information, the wireless apparatus caused to measure the propagation information may be determined on the basis of the estimated position in addition to the fault that possibly occurs. The measurement condition may be determined on the basis of the estimated position in addition to the fault that possibly occurs. For example, if the power generation rate in a predetermined area is reduced, the wireless apparatus installed in the area may be caused to be instructed to measure the propagation information.

By determining execution of fault detection based on the state information as described above, increase in traffic in the wireless section due to transmission of the propagation characteristic by the wireless apparatuses can be prevented in comparison with the case of steadily detecting a fault. Instead of the fault detection apparatus 101, the monitoring apparatus 270 may determine execution of fault detection, and the monitoring apparatus 270 may transmit instruction data for executing fault detection to the fault detection apparatus 101.

After the fault detection apparatus 101 transmits measurement instruction data to the target wireless apparatus according to the operation described above, the wireless apparatus having received the instruction measures the propagation information with a measurement condition of the instruction, calculates the propagation characteristic, and feeds back information representing the calculated propagation characteristic to the fault detection apparatus 101. Accordingly, the fault detection apparatus 101 executes detection of presence or absence of each fault on the basis of the acquired propagation characteristic.

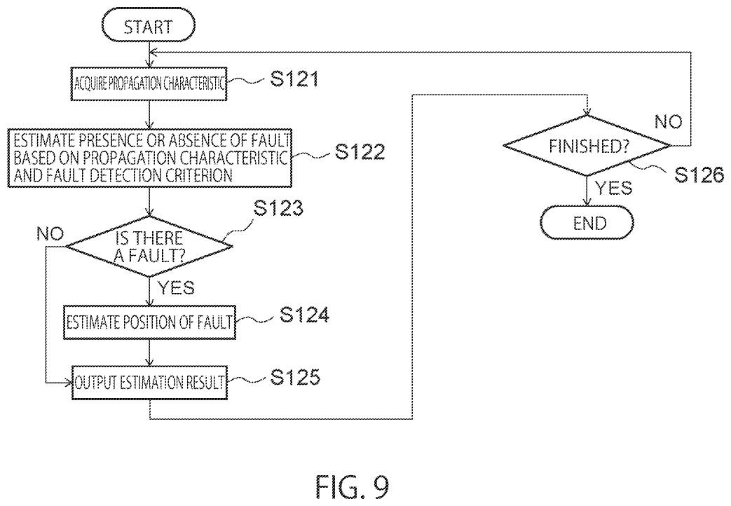

FIG. 9 is a flowchart of an example of the operation of the estimator 106 executing detection of presence or absence of a fault. The estimator 106 of the fault detection apparatus 101 acquires feedback information including the propagation characteristic calculated by at least one wireless apparatus 110 (S121). That is, the estimator 106 receives a signal including the calculated propagation characteristic, through the communicator 102. The feedback information may include not only the information on the propagation characteristic (the information on the propagation characteristic is an example of the first information), but also the identifier (ID) of the wireless apparatus as a transmission source, and the identifier (ID) of the wireless apparatus as the opposite party having performed measurement with the wireless apparatus as the transmission source. Furthermore, information on fault type to be detected may be included.

Next, the estimator 106 estimates presence or absence of a fault on the basis of the propagation characteristic acquired from the wireless apparatus 110 and of the fault detection criterion stored in the setting information storage 107 (S122). If the estimator 106 estimates that there is not a fault (NO in S123), information on an estimation result of this absence is presented to the operator or the like through the output device 109 (S125). On the contrary, if the estimator 106 determines that there is a fault (YES in S123), this estimator estimates the position at which the fault occurs, according to the detected fault (S124). The estimator 106 can estimate the position at which a fault occurs using position information that is on each wireless apparatus and is stored in the setting information storage 107, and the identifier of the wireless apparatus included in the feedback information acquired in step S121. For example, it is estimated that a fault occurs at the two wireless apparatuses having measured the propagation information, adjacent to the two wireless apparatuses, or in a section between these two wireless apparatuses. As for a certain fault type, a fault occurs in a wide range (for example, a case of weeds). In this case, estimation of the position is not required in some cases.

If the fault detection is continued (NO in S126), the processing returns to step S121. If not continued (YES in S126), this processing is finished. If the estimator 106 estimates that there is a fault, information indicating the detected fault type is presented to the operator through the output device 109 (S125). If the position at which the fault occurs is estimated, information on the estimated position is also presented to the operator. The fault detection apparatus 101 can detect each type of faults by executing the operation as described above for fault types to be detected.

If it is estimated that there is a fault, the fault detection apparatus 101 may acquire additional information from the sensor connected to the wireless apparatus 110 (the sensor mounted on the same equipment on which the wireless apparatus 110 is also mounted) in order to improve the estimation accuracy.

The sensor from which information is acquired is, for example, a sensor connected to the wireless apparatus 110 serving as a transmission source of the propagation characteristic information, or a sensor connected to the opposite wireless apparatus 110 that performs measurement with the transmission-source wireless apparatus 110. Alternatively, another sensor that can sense the proximity of any of these wireless apparatuses 110 may be adopted.

For example, in a case where a camera is connected to the wireless apparatus 110, the processor 104 transmits a signal of instructing the camera to take images via the wireless apparatus 110, through the communicator 102. The processor 104 receives a signal including video information (sensing information) taken by the camera, through the communicator 102. Accordingly, the processor 104 acquires a video signal taken by the camera, from the wireless apparatus 110. When the estimator 106 estimates the position at which a fault occurs, this estimator may select a camera that can image the position on the basis of the position information. By presenting the taken video information to the operator through the output device 109, the details and the like of a factor of the fault are allowed to be confirmed, and the fault detection result can be verified. For example, when a fault of intrusion of wildlife is detected, confirmation of the video information can confirm the details including specific individuals of wildlife (intruders are bears or monkeys), and intrusion time. The estimator 106 may verify whether the fault detection result is correct or not on the basis of the video signal and a model, such as a preliminarily learned neural network. As described above, only when it is estimated that a fault is present, the wireless apparatus 110 is allowed to transmit the video information, the communication traffic can be suppressed to be low in comparison with a case of steadily transmitting the video information. Consequently, according to this embodiment, the fault detection accuracy can be improved while suppressing increase in communication traffic.

Next, methods of determining the wireless apparatus that measures the propagation information, the type of propagation information to be measured, the type of propagation characteristic to be calculated from the propagation information, propagation characteristic observation duration, propagation characteristic acquiring cycle, the fault detection criterion for detecting a fault and the like are specifically described.

[Selection of Wireless Apparatus to Measure Propagation Information]

For example, the wireless apparatus that measures the propagation information is selected on the basis of the size of the area in which a fault to be detected is present. In this case, to detect a fault to occur in a wider area, the propagation information is measured between wireless apparatuses having a distance making the apparatuses relatively distant from each other. On the other hand, to detect a fault to occur in a smaller area, the propagation information is measured between wireless apparatuses having a distance making the apparatuses relatively near to each other.

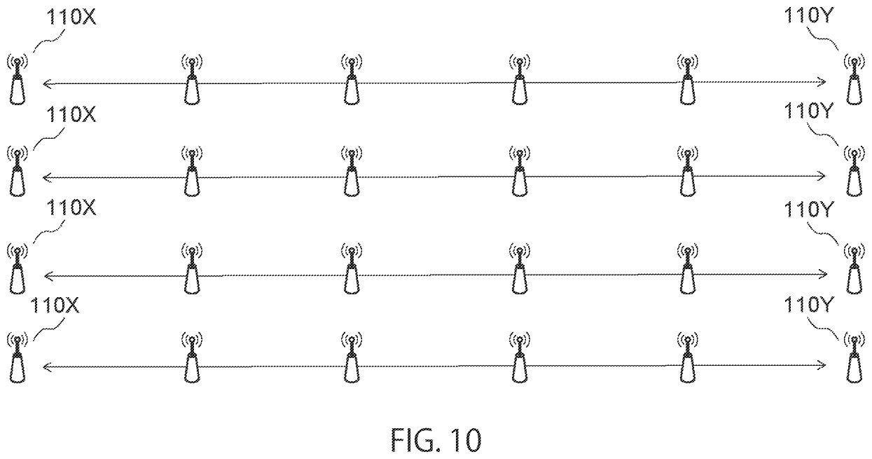

FIG. 10 shows an example of the wireless apparatuses to be selected to detect a fault occurring in a wide area. In this example, 24 wireless apparatuses are arranged in a matrix manner. To detect a fault occurring in a wide area, a pair of wireless apparatuses at the opposite ends on each row (a pair of wireless apparatus 110X and a wireless apparatus 110Y) are selected as wireless apparatuses that measure the propagation information. For example, in a case of a large-scale solar photovoltaic generation system, types of faults that include overgrowth of weeds, deposited snow, water immersion, ground subsidence, and ground prominence due to sediment influx occur in a relatively wide range at a certain time point. Ground subsidence or ground prominence results in variation in the positions of the wireless apparatuses 110. Accordingly, the propagation information between the wireless apparatuses having a distance making the apparatuses relatively distant from each other in the target area is acquired. Accordingly, the accuracy of detecting a fault of this type can be improved while suppressing the traffic of transmission by the wireless apparatus to the fault detection apparatus 101. If the propagation information is measured between all the wireless apparatuses including wireless apparatuses having a small distance, the number of wireless apparatuses that transmit the propagation information to the fault detection apparatus 101 increases, which increases the traffic in the wireless section. On the other hand, by adopting only the pair of the wireless apparatuses at the opposite ends as measurement targets, the fault can be highly accurately detected while reducing the number of wireless apparatuses that transmit the propagation characteristic. If a fault occurs in a geographically wide area, the propagation information measured between the wireless apparatuses having a large distance is relatively largely affected by the fault, thereby causing an advantage of easily detecting a fault. This is because the Fresnel zone affecting the propagation information between the wireless apparatuses having a large distance is large. The propagation information measured between the wireless apparatuses having a short distance is affected not only by a fault occurring in a wide area but also more largely by a fault locally occurring in vicinity of each of the apparatuses. This is because the Fresnel zone affecting the propagation information between the wireless apparatuses having a short distance is small. Accordingly, use of the propagation information between adjacent wireless apparatuses can be a factor of degrading the detection accuracy of types of faults occurring in a wide area.

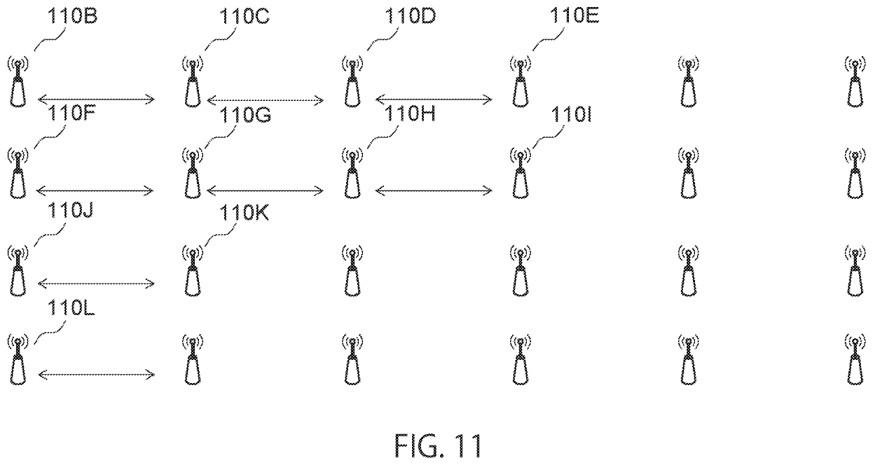

FIG. 11 shows an example of the wireless apparatuses to be selected to detect a fault occurring in a small area. Similar to the example of FIG. 10, 24 wireless apparatuses are arranged in a matrix manner. To detect a fault occurring in a small area, a pair of wireless apparatuses having a small distance are selected as wireless apparatuses that measure the propagation information. In the example of FIG. 11, to intend to detect a fault occurring around the upper left of the entire area, the propagation information is measured only between wireless apparatuses adjacent to each other in the lateral direction among the wireless apparatuses 110B to 110L that reside in a left area. Faults that include intrusion of animals or prowlers, deviation of mounts (variation in positions of wireless apparatuses 110), and partial breakage of local facilities, such as mounts or solar panels, occur in a relatively limited range at a certain time point. Accordingly, to detect such faults, a pair of wireless apparatuses having a small distance is selected. This selection can improve the accuracy of detecting a fault in a small area while reducing the number of wireless apparatuses that transmit the propagation characteristic. That is, when a fault occurs in a geographically small area, adverse effects tend to appear on the propagation information measured between wireless apparatuses that have a small distance therebetween and are installed near to a position at which the fault occurs. This is because the Fresnel zone affecting the propagation information between the wireless apparatuses having a short distance is small. Consequently, even if only the propagation information measured between the wireless apparatuses having a small distance is used, the fault can be detected. If the propagation information measured between the wireless apparatuses having a large distance therebetween is also used, a fault occurring in a wide area also more largely affects the information. Accordingly, this can become a factor of degrading the detection accuracy.

[Propagation Characteristic Observation Duration Between Wireless Apparatuses, Propagation Characteristic Acquiring Cycle, and Type of Propagation Characteristic to be Acquired]

For example, according to the duration during which a fault to be detected is continuously present, the propagation characteristic observation duration is set. In this case, to detect a fault that is continuously present for a longer duration, the propagation characteristic observation duration between wireless apparatuses is set to be long. On the other hand, to detect a fault that is present for a shorter duration, the propagation characteristic observation duration between wireless apparatuses is set to be short. As for variation in propagation characteristic in the observation duration, a fault detection criterion may be provided according to the length of the observation duration.

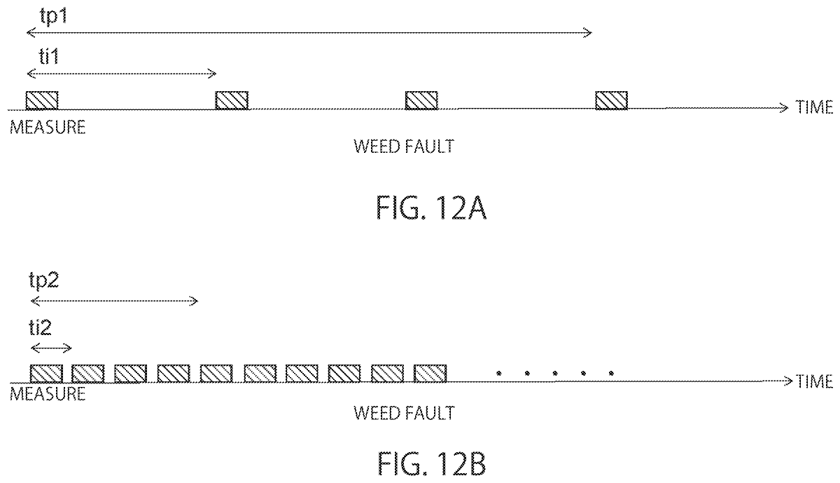

FIG. 12A shows an observation duration “tp1” in a case of detecting a fault that is continuously present for a long duration. FIG. 12B shows an observation duration “tp2” for detecting a fault occurring in a short duration. Setting of tp1>tp2 can highly accurately detect both the faults. Each one of hatched rectangles represents that measurement of the propagation information between the wireless apparatuses, calculation of the propagation characteristic, and feedback of information on the propagation characteristic are performed at timing of the position of the rectangle.

For example, in the case of a large-scale solar photovoltaic generation system, a fault such as overgrowth of weeds is continuously present for e.g., one month or more. To detect such a fault, the propagation characteristic between wireless apparatuses are observed for one month or more, and overgrowth of weeds can be detected based on variation in propagation characteristic. On the other hand, faults such as of wildlife and intruders are typically present for a relatively short time ranging from several seconds to several minutes at a certain place. There is a low possibility of being continuously present for one week or more. Such a fault can be detected by observing the propagation characteristic between the wireless apparatuses for a relatively short time duration, such as several minutes or less (for example, a time slot in which wildlife tends to appear).

According to the speed of change in fault to be detected, the propagation characteristic acquiring cycle may be set. In this case, to detect a relatively slowly varying fault, the propagation characteristic acquiring cycle between the wireless apparatuses may be set to be long, and a fault detection criterion according to the change in the propagation characteristic may be provided. On the other hand, to detect a relatively rapidly varying fault, the propagation characteristic acquiring cycle between the wireless apparatuses may be set to be short, and a fault detection criterion may be provided based on the propagation characteristic.

FIG. 12A shows an acquisition cycle “ti1” in a case of detecting a fault having a slow fault varying speed. FIG. 12B shows an acquisition cycle “ti2” in a case of detecting a fault having a fast fault varying speed. Setting of ti1>ti2 can highly accurately detect both the faults.

For example, in the case of a large-scale solar photovoltaic generation system, a fault such as overgrowth of weeds can be regarded to have relatively slow change speed because the growth is slow for several months, for example. To detect such a fault, it is conceivable that the received signal strength indicator (hereinafter, RSSI) is measured, for example between wireless apparatuses. In this case, there is no need to measure the propagation information, i.e., RSSI, at a short cycle, such as one second interval, between the wireless apparatuses, or acquire a representative value for one minute and transmit the value as the propagation characteristic at one minute interval. For example, measurement may be performed multiple times, at a cycle, such as once a week or a month, at ten-second interval or at one-minute interval. A representative value thereof, such as the maximum value, the mean value or the median value thereof, may then be acquired and transmitted. Such instruction of measurement may be performed by the processor 104 once a week or a month. The propagation characteristic acquired as described above are observed for a relatively long duration, such as one month or several months. If the amount of reduction thereof exceeds a predetermined fault detection criterion (threshold), overgrowth of weeds can be detected. Upon detection of overgrowth of weeds, the processor 104 instructs the actinometer (sensor) connected to the wireless apparatus to measure the amount of insolation, acquires the information thereof, and compares the information with a predetermined reference amount of insolation, thereby allowing the detection accuracy to be improved. That is, if the amount of insolation is equal to or lower than a predetermined level, there is a possibility that the weather is cloudy. If the amount of insolation is larger than the predetermined level, the possibility of overgrowth of weeds can be estimated to be high.

Note that the state change of faults, such as deposited snow and water immersion, does not have a high speed. However, the state change is fast in comparison with that of overgrowth of weeds. To detect such faults, measurement is performed multiple times more frequently than detection of overgrowth of weeds, for example, once every ten minutes, once an hour, at a several-second interval, or a ten-second interval. A representative value, such as the maximum value, mean value, or median value thereof is acquired as propagation characteristic, and is transmitted. Accordingly, highly accurate detection can be achieved.

On the other hand, faults such as wildlife and intruders accompanied by spontaneous motions of bodies and movements. Accordingly, the state change can be regarded to have a relatively high speed. The change in propagation characteristic due to such faults is relatively fast. Accordingly, to detect the change, the propagation characteristic are required to be acquired between wireless apparatuses at a relatively short cycle ranging from one second to several seconds, and are required to be observed for several minutes to several tens of minutes. Also in this case, similar to the above description, the RSSI can be measured as propagation information, and used for detection. For example, between the wireless apparatuses, the RSSI may be measured for several minutes at a relatively short cycle ranging from one second to several seconds, and the value (amount of variation) representing variation, such as the variance, standard deviation, and the difference between the maximum value and the minimum value may be acquired as propagation characteristic. If the amount of variation is larger than a predetermined fault detection criterion (threshold), it can be determined that a fault is present. As described above, in case wildlife or an intruder are detected, a detailed position at which the wildlife or the intruder is present can be estimated using the position information on the wireless apparatus having propagation characteristic about RSSI higher than a predetermined fault detection criterion. In this case, the processor 104 instructs the camera connected to the wireless apparatus to take images, and acquires video information, thereby allowing the detection accuracy of wildlife or an intruder to be improved.

As described above, according to this embodiment, the wireless apparatuses are caused to measure appropriate propagation information for each fault type to be detected, and appropriate propagation characteristic are fed back, which can highly accurately detect a fault while reducing the traffic of information transmitted by the wireless apparatuses. For example, between appropriate wireless apparatuses defined for each type of faults to be detected, appropriate propagation information is measured for an appropriate time at appropriate frequency, and appropriate transmission characteristic are calculated, thereby allowing a fault occurring in an environment around the wireless apparatuses to be detected highly accurately and highly efficiently. The fault can be detected without specifically providing the wireless apparatuses with a sensor or the like for detecting a fault to be detected. Furthermore, in case a fault occurs, the fault can be soon addressed.

By acquiring data through the sensor or the camera provided in or adjacent to equipment only as required, the accuracy of fault detection can be improved while preventing the sensor or the camera from unnecessarily communicating. Consequently, even in a case where in normal times the wireless apparatus transmits information about the state of equipment to which the wireless apparatus is connected (for example, information about solar panels), a fault can be highly accurately detected without affecting transmission of the information.

### Second Embodiment

In the first embodiment, the propagation characteristic are calculated by the wireless apparatus 110. In a second embodiment, the fault detection apparatus 101 calculates the propagation characteristic using the propagation information measured by the wireless apparatus. The other points are similar to those of the first embodiment.

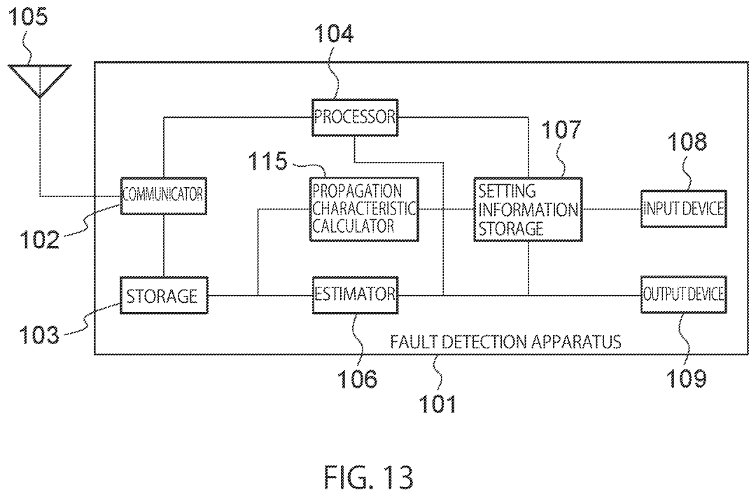

FIG. 13 is a block diagram of a fault detection apparatus 101 according to the second embodiment. A propagation characteristic calculator 115 is added. In addition to the processor 104 and the estimator 106, the propagation characteristic calculator 115 may be achieved by a processing apparatus.

The processor 104 acquires the propagation information instead of acquiring information on the propagation characteristic, from the wireless apparatus 110. The storage 103 stores the propagation information acquired by the processor 104. Similar to the first embodiment, the processor 104 instructs the selected wireless apparatus to measure the propagation information according to a method determined in a manner similar to that of the first embodiment, and transmits instruction data to be transmitted to the fault detection apparatus 101. Similar to the first embodiment, a condition of designating the wireless apparatuses, and a condition of measurement (the type of propagation information to be measured by the wireless apparatuses, the measurement time duration, or the number of measurements, the measurement interval, etc.) are defined for each type of faults to be detected. The propagation characteristic calculator 115 calculates the propagation characteristic from the propagation information stored in the storage 103. Similar to the first embodiment, the condition of calculating the propagation characteristic is defined for each fault type to be detected, and is stored in the setting information storage 107. Similar to the first embodiment, the estimator 106 estimates presence or absence of a fault on the basis of the fault detection criterion defined for each fault to be detected and of the propagation characteristic calculated by the propagation characteristic calculator 115. Furthermore, the position at which the fault occurs is estimated.

According to this embodiment, the wireless apparatus transmits the measured propagation information to the fault detection apparatus 101. Accordingly, although the traffic in the wireless section for fault detection increases in comparison with the first embodiment, the computing load on the wireless apparatus can be reduced, and the power consumption can be reduced.

(Hardware Configuration)

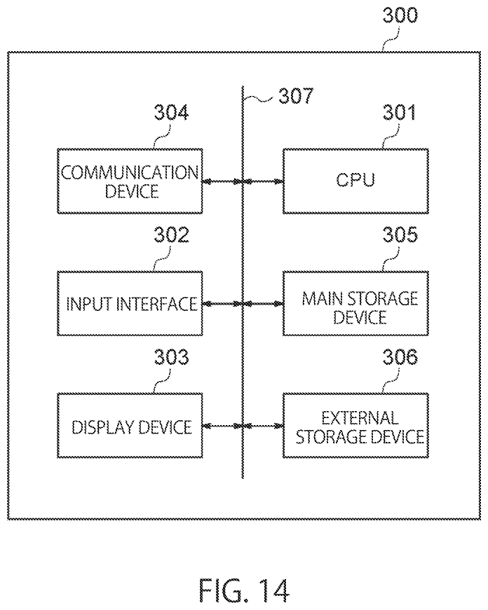

FIG. 14 illustrates a hardware configuration of the fault detection apparatus (information processing apparatus) 101 according to the present embodiment. The information processing apparatus 101 according to the present embodiment is configured with a computer device 300. The computer device 300 includes a CPU 301, an input interface 302, a display device 303, a communication device 304, a main storage device 305 and an external storage device 306, and these are connected to each other with a bus 307.

The CPU (Central Processing Unit) 301 executes a computer program (prediction program) which realizes the above-described respective functional configurations of the information processing apparatus 101 on the main storage device 305. The computer program may not be a single program but a plurality of programs or a combination of scripts. By the CPU 301 executing the computer program, the respective functional configurations are realized.

The input interface 302 is a circuit for inputting an operation signal from the input device such as a keyboard, a mouse and a touch panel, to the information processing apparatus 101. The input function of the information processing apparatus 101 can be constructed on the input interface 302.

The display device 303 displays data or information output from the information processing apparatus 101. While the display device 303 is, for example, an LCD (Liquid Crystal Display), a CRT (Cathode-Ray Tube), and a PDP (Plasma Display Panel), the display device 303 is not limited to this. The data or the information output from the computer device 300 can be displayed by this display device 303. The output device of the information processing apparatus 101 can be constructed on the display device 303.

The communication device 304 is a circuit for the information processing apparatus 101 to communicate with an external device in a wireless or wired manner. Information can be input from the external device via the communication device 304. Information input from the external device can be stored in a DB.

The main storage device 305 stores a program (prediction program) which realizes processing of the present embodiment, data required for execution of the program, data generated by execution of the program, and the like. The program is developed and executed on the main storage device 305. While the main storage device 305 is, for example, a RAM, a DRAM and an SRAM, the main storage device 305 is not limited to this. The storage in each embodiment may be constructed on the main storage device 305.

The external storage device 306 stores the above-described program, data required for execution of the program, data generated by execution of the program, and the like. These kinds of program and data are read out to the main storage device 305 upon processing of the present embodiment. While the external storage device 306 is, for example, a hard disk, an optical disk, a flash memory and a magnetic tape, the external storage device 306 is not limited to this. The storage in each embodiment may be constructed on the external storage device 306.

Note that the above-described program may be installed in the computer device 300 in advance or may be stored in a storage medium such as a CD-ROM. Further, the program may be uploaded on the Internet.

Note that the computer device 300 may include one or a plurality of the processors 301, the input interfaces 302, the display devices 303, the communication devices 304 and the main storage devices 305, or peripheral equipment such as a printer and a scanner may be connected to the computer device 300.

Further, the information processing apparatus 101 may be configured with a single computer device 300 or may be configured as a system including a plurality of computer devices 300 which are connected to each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electronic apparatus, comprising:
a processor configured to determine, among first wireless communication apparatuses arranged at first positions in an environment, a second wireless communication apparatus and a third wireless communication apparatus based on a fault to be detected in the environment, the third wireless apparatus measuring first information associated with propagation of a radio wave with the second wireless communication apparatus.

2. The electronic apparatus according to claim 1, further comprising:
a communicator configured to transmit instruction data of measuring the first information between the second wireless communication apparatus and the third wireless communication apparatus, to at least one of the second wireless communication apparatus and the third wireless communication apparatus.

3. The electronic apparatus according to claim 2, further comprising:
an estimator configured to acquire the first information from at least one of the second wireless communication apparatus and the third wireless communication apparatus, and estimates presence or absence of the fault, based on the first information.

4. The electronic apparatus according to claim 3,
wherein the estimator is configured to estimate presence or absence of the fault, based on a fault detection criterion according to the fault to be detected.

5. The electronic apparatus according to claim 3,
wherein the processor is configured to acquire second information on a state of the first wireless communication apparatus or a state of equipment provided with the first wireless communication apparatus, and determine whether the presence or absence of the fault is required to be estimated based on the second information, and
if the presence or absence of the fault is required to be estimated, the communicator transmits the instruction data.

6. The electronic apparatus according to claim 5,
wherein the equipment is power generation equipment, and
the second information includes information on a voltage or a current of generated power of the equipment.

7. The electronic apparatus according to claim 3,
wherein if the fault is detected, the estimator is configured to estimate a position at which the fault is present, based on position information on at least one of the second wireless communication apparatus and the third wireless communication apparatus.

8. The electronic apparatus according to claim 7,
wherein the communicator receives sensing information on the environment at the position of the fault, from a sensor capable of sensing the environment at the estimated position of the fault, and
the estimator estimates the presence or absence of the fault, further based on the sensing information.

9. The electronic apparatus according to claim 3, further comprising:
an output device configured to output an estimation result of the fault by the estimator.

10. The electronic apparatus according to claim 1,
wherein according to the fault to be detected, a distance between the second wireless communication apparatus and the third wireless communication apparatus varies.

11. The electronic apparatus according to claim 10,
wherein among the fault to be detected, a first type of the fault is a fault that possibly occurs in a first area, and
a second type of the fault is a fault that possibly occurs in a second area wider than the first area,
the distance between the second wireless communication apparatus and the third wireless communication apparatus in a case where the fault is the second type is longer than the distance between the second wireless communication apparatus and the third wireless communication apparatus in a case where the fault is the first type.

12. The electronic apparatus according to claim 3,
wherein according to the fault to be detected, an interval of acquiring the first information varies.

13. The electronic apparatus according to claim 12,
wherein among the fault to be detected, a change speed in a state in a first type of the fault is lower than a change speed in a state of a second type of the fault, and
the interval of acquiring the first information in a case where the type of the fault is the first type is longer than that the interval of acquiring the first information in a case where the type of the fault is the second type.

14. The electronic apparatus according to claim 3,
wherein according to the fault to be detected, a length of a duration for acquiring the first information varies.

15. The electronic apparatus according to claim 14,
wherein among the fault to be detected, a first type of the fault is continuously present longer than a second type of the fault, and
a duration for acquiring the first information in a case where the type of the fault is the first type is longer than a duration for acquiring the first information in a case where the type of the fault is the second type.

16. The electronic apparatus according to claim 3,
wherein among the fault to be detected, a change speed in a state of a first type of the fault is lower than a change speed in a state of a second type of the fault,
in a case where the type of the fault is the first type, the first information is a representative value of strength information of a signal exchanged between the second wireless communication apparatus and the third wireless communication apparatus, and
in a case where the type of the fault is a second type, the first information is a value indicating variation in the strength information.

17. The electronic apparatus according to claim 1,
wherein a type of the fault includes at least one of overgrowth of plants, wildlife intrusion, prowler intrusion, variation in a position of the first wireless communication apparatus, deposited snow, water immersion, ground subsidence, and sediment influx.

18. An electronic system, comprising:
the electronic apparatus according to claim 1; and
the first wireless communication apparatuses.

19. A method, comprising:
determining, among first wireless communication apparatuses arranged at first positions in an environment, a second wireless communication apparatus and a third wireless communication apparatus based on a fault to be detected in the environment, the third wireless apparatus measuring first information associated with propagation of a radio wave with the second wireless communication apparatus.

20. A non-transitory computer readable medium having a computer program stored therein which causes a computer to perform processes when executed by the computer, the processes comprising:
determining, among first wireless communication apparatuses arranged at first positions in an environment, a second wireless communication apparatus and a third wireless communication apparatus based on a fault to be detected in the environment, the third wireless apparatus measuring first information associated with propagation of a radio wave with the second wireless communication apparatus.
